(19) United States
(12) Patent Application Publication
(10) Pub. No.: US 2026/0343513 A1
(43) Pub. Date: Oct. 29, 2026

(54) TERMINAL AND RADIO COMMUNICATION METHOD

(71) Applicant: NTT DOCOMO, INC., Tokyo (JP)

(72) Inventors: Takuma Nakamura, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 19/116,124

(22) PCT Filed: Sep. 30, 2022
(86) PCT No.: PCT/JP2022/036871

§ 371 Date: Mar. 27, 2025

(51) Int. Cl. H04W 72/0457

(52) U.S. Cl. CPC H04W 72/0457

(57) ABSTRACT

A terminal having at least two antenna ports and two transmission chains, switches the antenna ports and the transmission chains. The terminal assumes that one transmission chain is configured when using a frequency band in which transmission by two antenna ports is restricted.

### TECHNICAL FIELD

This disclosure relates to terminal and radio communication method that support uplink switching.

### BACKGROUND ART

The 3rd Generation Partnership Project (3GPP) has specified the 5th generation mobile communication system (5G, also known as New Radio (NR) or Next Generation (NG)) and is also proceeding with the specification of the next generation called Beyond 5G, 5G Evolution or 6G.

For example, 3GPP Release 17 specifies UL Tx switching (Uplink switching) using 2 antenna ports and 2 Tx chains to enhance uplink (UL) transmission by multicarriers (For example, Non-Patent Literature 1). Thus, SUL (Supplementary UL) and UL carrier aggregation (CA) can be configured while using two frequency bands (It can be called a band or a carrier).

In 3GPP Release 18, it is considered to increase the number of supported bands to 3 or more. As a response to such an increase in the number of bands, it is considered to reduce the complexity of a terminal (User Equipment, UE) (Non-Patent Literature 2).

Specifically, it is considered to limit the bands that can be transmitted by two antenna ports or to limit the combination of bands that can be transmitted simultaneously.

### CITATION LIST

### Non-Patent Literature

[Non-Patent Literature 1] 3GPP TS 38.214V17.2.0 , 3rd Generation Partnership Project; Technical Specification Group Radio Access Network; NR; Physical layer procedures for data (Release 17), 3GPP, June 2022
[Non-Patent Literature 2] “Summary of discussion on multi-carrier UL Tx switching scheme,” R1-2207942, 3GPP 3GPP TSG RAN WG1 #110, 3GPP, August 2022

### SUMMARY OF INVENTION

However, when the above-mentioned band restriction on UL Tx switching is applied, the following problems are considered. Specifically, the state (handling) of the Tx chain when the band is used is not clear. Therefore, there is a concern that the UE cannot always perform appropriate operation with respect to UL Tx switching.

Therefore, the following disclosure has been made in view of such situation, and is intended to provide a terminal and a radio communication method which can realize appropriate operation including the Tx chain even when the band restriction on UL Tx switching is applied.

One aspect of the present disclosure is a terminal (UE200) including a transmission unit (radio signal transmission and reception unit 210) having at least two antenna ports and two transmission chains and switches the antenna ports and the transmission chains, and a control unit (control unit 270) that assumes that one transmission chain is configured when a frequency band in which transmission by the two antenna ports is restricted is used.

One aspect of the present disclosure is a terminal (UE200) including a transmission unit (radio signal transmission and reception unit 210) having at least two antenna ports and two transmission chains and switches the antenna ports and the transmission chains, and a control unit (control unit 270) that assumes that the transmission chains can be configured when a combination of frequency bands in which simultaneous transmission is restricted is used.

One aspect of the present disclosure is a terminal (UE200) including a transmission unit (radio signal transmission and reception unit 210) having at least two antenna ports and two transmission chains and switches the antenna ports and the transmission chains, and a control unit (control unit 270) that assumes that the transmission chains cannot be configured when a combination of frequency bands in which simultaneous transmission is restricted is used.

One aspect of the present disclosure is a terminal (UE200) including a transmission unit (radio signal transmission and reception unit 210) having at least two antenna ports and two transmission chains and switches the antenna ports and the transmission chains, and a control unit (control unit 270) that assumes that the transmission chains can be configured when a combination of frequency bands in which simultaneous transmission is restricted is used.

### BRIEF DESCRIPTION OF DRAWINGS

FIG. 1 is an overall schematic configuration diagram of a radio communication system 10.

FIG. 2 is a diagram showing an example of the configuration of radio frames, sub-frames and slots used in the radio communication system 10.

FIG. 3 is a diagram showing an example of the configuration of UL Tx switching in a UE200.

FIG. 4 is a functional block diagram of a qNB100 and UE200.

FIG. 5 is a diagram showing an example of Configuring the antenna port and Tx chain (Alt 1) according to operation example 1-1.

FIG. 6 is a diagram showing an example of configuring the antenna port and Tx chain (Alt 1) according to operation example 1-2.

FIG. 7 is a diagram showing an example of the correspondence between the antenna port and Tx chain and the band in operation example 1-2.

FIG. 8 is a diagram showing an example of the configuring the antenna port and Tx chain (Alt 2) in operation example 1-2.

FIG. 9 is a diagram showing an example of the configuring the antenna port and Tx chain (Alt 3) in operation example 1-2.

FIG. 10 is a diagram showing an example of the configuring the antenna port and Tx chain (Alt 1) in operation example 2.

FIG. 11 is a diagram showing an example of configuring the antenna port and Tx chain (Alt 2) in operation example 2.

FIG. 12 is a diagram showing an example sequence related to transmission and reception of UL Tx switching capability information and indication information.

FIG. 13 is a diagram showing an example of hardware configuration of the gNB100 and the UE200.

FIG. 14 is a diagram showing configuration example of a vehicle 2001.

### DESCRIPTION OF EMBODIMENT

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

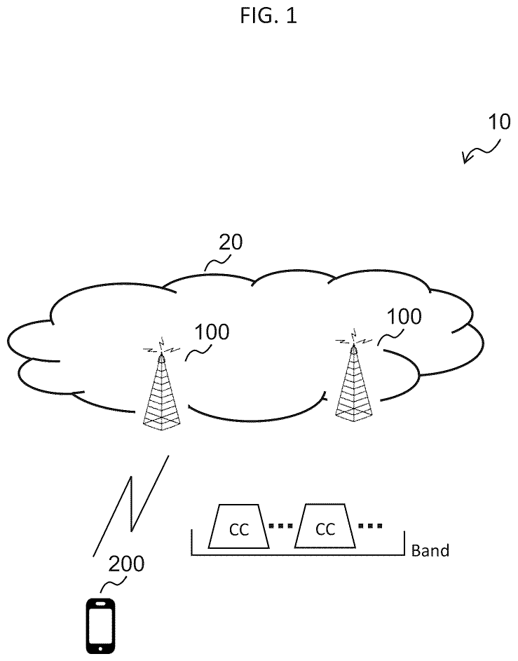

FIG. 1 is an overall schematic configuration diagram of the radio communication system 10 according to this embodiment. The radio communication system 10 is a radio communication system according to the 5G New Radio (NR) and includes the Next Generation-Radio Access Network 20 (hereinafter referred to as NG-RAN20 and terminal 200 (UE200, User Equipment, UE). The radio communication system 10 may be a radio communication system according to the system called Beyond 5G, 5G Evolution or 6G.

The NG-RAN20 includes a radio base station 100 (qNB100). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), and is connected to a core network (5GC, not shown) according to 5G. The NG-RAN20 and the 5GC may be simply described as a “network.”

The gNB100 is a radio base station in accordance with 5G, and performs radio communication with the UE200 in accordance with 5G. The qNB100 and the UE200 can support Massive MIMO (Multiple-Input Multiple-Output), which generates antenna beams (Hereinafter, beam) with higher directivity by controlling radio signals transmitted from a plurality of antenna elements, carrier aggregation (CA), which bundles a plurality of component carriers (CC), and dual connectivity (DC), which simultaneously communicates between the UE and each of the two NG-RAN Nodes.

The type of DC may be Multi-RAT Dual Connectivity (MR-DC), which utilizes multiple radio access technologies, or NR-NR Dual Connectivity (NR-DC), which utilizes only NR. The MR-DC may be E-UTRA-NR Dual Connectivity (EN-DC), in which the eNB constitutes the master node (MN) and the gNB constitutes the secondary node (SN), or NR-E-UTRA Dual Connectivity (NE-DC), which is the opposite.

The qNB100 can transmit a plurality of beams with different transmission directions (May be referred to simply as direction, or radial direction, coverage, etc.) in space and time division. The gNB100 may transmit a plurality of beams simultaneously.

The radio communication system 10 may also support a plurality of frequency ranges (FRs) as shown below.
FR1: 410 MHz~7.125 GHz
FR2-1: 24.25 GHz~52.6 GHz

In FR1, a sub-carrier spacing (SCS) of 15, 30 or 60 KHz may be used and a bandwidth (BW) of 5~100 MHz may be used. FR2-1 has a higher frequency than FR1 and a sub-carrier spacing (SCS) of 60 or 120 KHz (240 KHz may be included) may be used and a bandwidth (BW) of 50~400 MHz may be used.

SCS may be interpreted as numerology. Numerology is defined in 3GPP TS38.300 and corresponds to one sub-carrier spacing in the frequency domain.

Furthermore, the radio communication system 10 supports a higher frequency band than the frequency band of the FR2-1. Specifically, the radio communication system 10 supports a frequency band exceeding 52.6 GHz up to 71 GHz. Such a high frequency band may be called the FR2-2.

When using a band exceeding 52.6 GHz, cyclic prefix-orthogonal frequency division multiplexing (CP-OFDM)/discrete Fourier transform-spread (DFT-S-OFDM) with a larger sub-carrier spacing (SCS) may be applied.

In a high frequency band such as the FR2-2, as described above, an increase in phase noise between carriers becomes a problem. Therefore, a larger (wider) SCS or a single carrier waveform may be required.

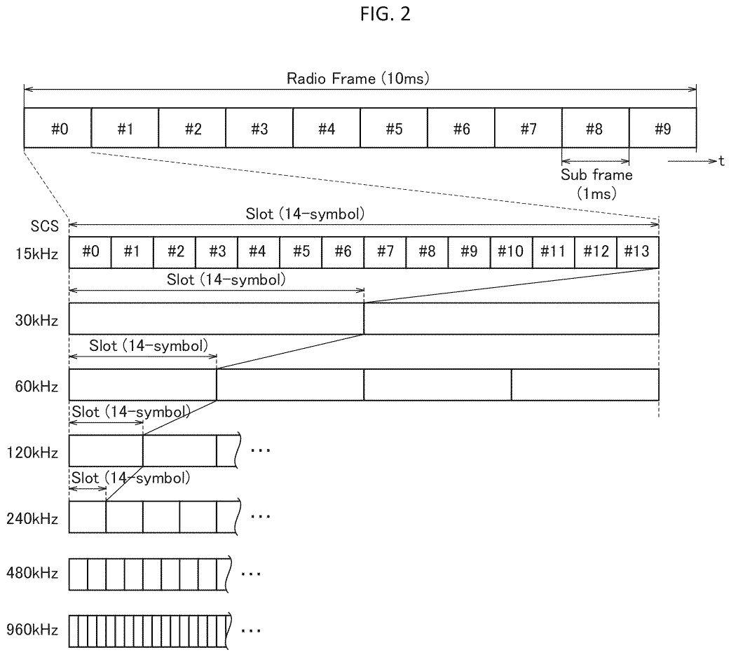

The larger the SCS, the shorter the symbol/CP (cyclic prefix) period and the slot period (when the configuration of 14 symbols/slots is maintained). FIG. 2 shows an example of the configuration of radio frames, subframes and slots used in the radio communication system 10.

When the configuration of 14 symbols/slots is maintained, the larger (wider) the SCS, the shorter the symbol period (and slot period). The symbol period may be referred to as a symbol length, time direction, or time domain. The frequency direction may be referred to as a frequency domain, resource block, subcarrier, BWP (bandwidth part), or the like.

The frequency resources may include component carriers (CC), subcarriers, resource blocks (RB), resource block groups (RBG), BWP (bandwidth part), or the like. The time resources may include symbols, slots, minislots, subframes, radio frames, DRX (Discontinuous Reception) periods, or the like.

The number of symbols constituting 1 slot may not necessarily be 14 symbols (For example, 28, 56 symbols). The number of slots per subframe may be different depending on the SCS.

In the radio communication system 10, an SSB (SS/PBCH Block) consisting of a synchronization signal (SS) and a downlink physical broadcast channel (PBCH) may be used.

The SSB is periodically transmitted from the network in order for the UE200 to perform cell ID and reception timing detection at the start of communication. In the NR, the SSB is also used to measure the reception quality of each cell. 5, 10, 20, 40, 80, and 160 milliseconds may be specified as the SSB transmission period. The UE200 for initial access may assume a transmission period of 20 milliseconds.

In addition, the radio communication system 10 may enhance uplink (UL) transmission by multi-carrier. Specifically, the UE200 may use a plurality of antenna ports and a plurality of Tx chains (transmission lines) in UL Tx switching (Uplink switching).

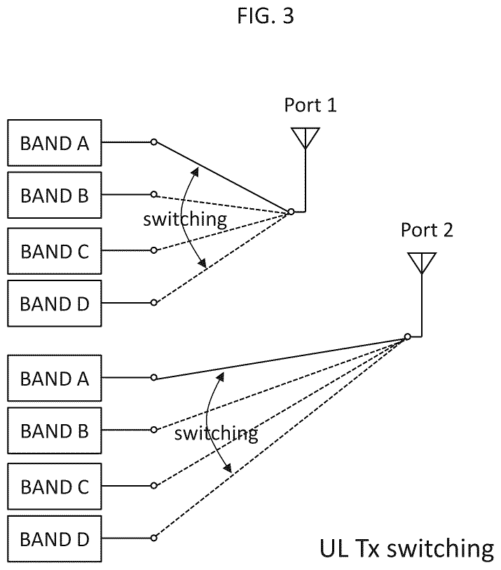

FIG. 3 shows an example configuration of UL Tx switching in the UE200. 3GPP Release 16 and 17 may support UL Tx switching (also called 2Tx-2Tx UL Tx switching) that can switch UL transmission between 2 bands (or 2 carriers). Such UL Tx switching may be suitably used in SUL (Supplementary UL) or Inter-band CA and EN-DC. Note that SUL is associated with a conventional DL/UL carrier pair, and carriers (bands) operating in a lower frequency band may be used.

3GPP Release 18 further expands the function of UL Tx switching. Specifically, as shown in FIG. 3, it is planned to switch UL transmission between 3 or 4 bands (an example of 4 bands is shown in FIG. 3).

Specifically, the UE200 has 2 antenna ports and 2 Tx chains, and each Tx chain can be switched to one of Bands A, B, C, or D. Such UL Tx switching may be called 2Tx−2Tx (−2Tx−2Tx) switching. Tx chains may be selectively connected to a plurality of antenna ports.

Until 3GPP Release 17, there were restrictions such as that the switchable bands were limited to the same band, but such restrictions can be eliminated. This is expected to greatly improve the throughput of UL.

In response to such an increase in the number of bands, the radio communication system 10 may selectively apply a plurality of UL Tx switching mechanisms, such as a switching mechanism that focuses on improving throughput and a switching mechanism that considers the complexity of the UE200.

In the switching mechanism that focuses on throughput improvement, it is possible to freely switch between 3 or 4 bands without any particular restriction. In the switching mechanism that considers complexity reduction of the UE200, it is possible to envisage switching in which the number of bands that can be switched can be configured by signaling, or in which an anchor band is configured and band switching is limited via the anchor band.

In addition, in order to reduce complexity of the UE200, the frequency bands (bands) that can be transmitted using 2 antenna ports may be limited. Specifically, the UE200 may support transmission using 2 antenna ports only in some of the bands configured for UL Tx switching.

In this case, the UE200 may support up to 2 Tx chains with at least 2 bands, as in 3GPP Release 17. Furthermore, such a limitation may be applied to both 3 and 4 bands, or only 4 bands.

Furthermore, such a limitation may be applied to both dual UL cases and switched UL cases, or only dual UL cases. The dual UL case may be interpreted as a case in which two bands transmit ULs simultaneously, and the switched UL case may be interpreted as a case in which one (single) band transmits ULS simultaneously.

To reduce the complexity of the UE200, the combination of bands that can be simultaneously transmitted may be limited. Specifically, the UE200 may support only part of the dual UL case (band pair). In this case, the UE200 may support at least one band pair, as in 3GPP Release 17.

### (2) Function Block Configuration of Radio Communication System

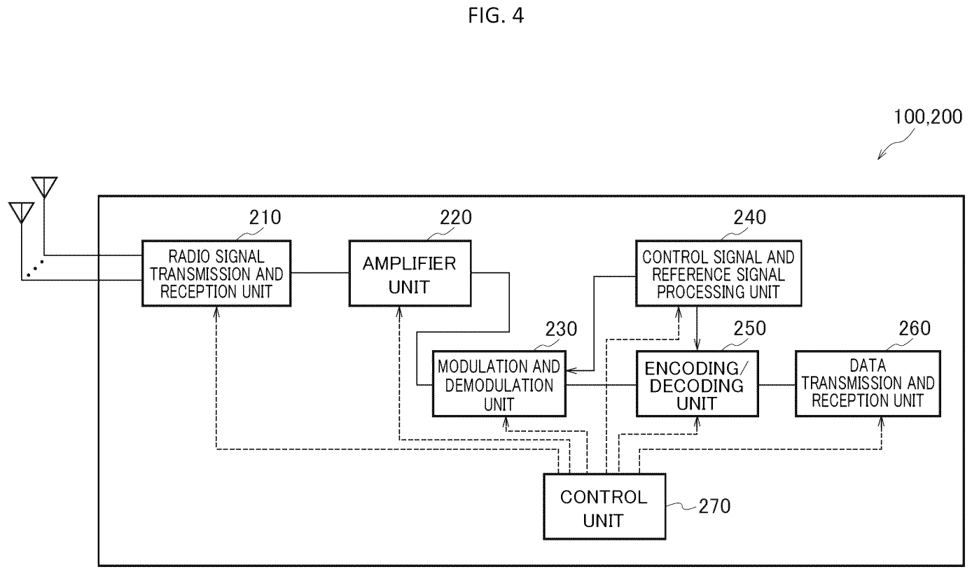

Next, the functional block configuration of the radio communication system 10 will be described. Specifically, the functional block configuration of the UE200 will be described. FIG. 4 is a functional block configuration diagram of the gNB100 and the UE200.

As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

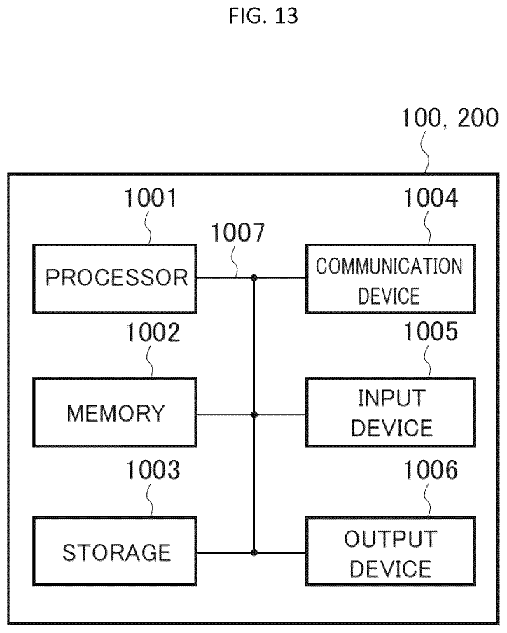

Note that only the main functional blocks related to the description of the embodiment are shown in FIG. 4, and the UE200 (gNB100) has other functional blocks (For example, a power supply unit). FIG. 4 shows the functional block configuration of the UE200. For the hardware configuration, refer to FIG. 13.

The radio signal transmission and reception unit 210 transmits and receives radio signals in accordance with NR. The radio signal transmission and reception unit 210 can correspond to Massive MIMO for generating a beam with higher directivity by controlling radio (RF) signals transmitted from a plurality of antenna elements, carrier aggregation (CA) for bundling a plurality of component carriers (CC), and dual connectivity (DC) for simultaneously communicating between UE and each of the two NG-RAN Nodes.

The radio signal transmission and reception unit 210 may have a plurality of antenna ports (Port 1, 2) and a Tx chain (transmission lines) as shown in FIG. 3. The radio signal transmission and reception unit 210 may switch between two antenna ports and two Tx chains. In this embodiment, the radio signal transmission and reception unit 210 may have at least two antenna ports and two Tx chains (transmission lines), and may constitute a transmission unit for switching the antenna ports and transmission lines.

Specifically, the radio signal transmission and reception unit 210 may switch between the antenna ports and/or Tx chains based on any one of a plurality of UL Tx switching mechanisms. As described above, the switching mechanism may include a switching mechanism focusing on improving throughput and a switching mechanism considering reducing the complexity of the UE200.

In addition, the radio signal transmission and reception unit 210 may have an option (Option 1, may be called switched UL case) that cannot support simultaneous transmission of two or more carriers using the Tx chain, and an option (Option 2, may be called dual UL case) that can simultaneously configure (transmit) two or more carriers (which may be interpreted as component carriers).

The amplifier unit 220 comprises a PA (Power Amplifier)/LNA (Low Noise Amplifier), etc. the amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 performs data modulation/demodulation, transmission power setting, resource block allocation, and the like for each predetermined communication destination (gNB100, etc.) . In the modulation and demodulation unit 230, cyclic prefix-orthogonal frequency division multiplexing (CP-OFDM)/discrete Fourier transform-spread (DFT-S-OFDM) may be applied. The DFT-S-OFDM may be used not only for the uplink (UL) but also for the downlink (DL).

The control signal and reference signal processing unit 240 performs processes related to various control signals transmitted and received by the UE200, and processes related to various reference signals transmitted and received by the UE200.

Specifically, the control signal and reference signal processing unit 240 receives various control signals transmitted from the gNB100 via a predetermined control channel, for example, control signals of the radio resource control layer (RRC). The control signal and reference signal processing unit 240 also transmits various control signals to the gNB100 via a predetermined control channel.

The control signal and reference signal processing unit 240 executes processing using reference signals (RS) such as Demodulation Reference Signal (DMRS) and Phase Tracking Reference Signal (PTRS).

The DMRS is a reference signal (pilot signal) known between individual terminal base stations and terminals for estimating the fading channel used for data demodulation. The PTRS is an individual terminal reference signal for estimating phase noise, which is a problem in a high frequency band.

In addition to the DMRS and PTRS, the reference signal may include Channel State Information-Reference Signal (CSI-RS), Sounding Reference Signal (SRS), and Positioning Reference Signal (PRS) for positional information.

The channel may include a control channel and a data channel. The control channel may include PDCCH (Physical Downlink Control Channel), PUCCH (Physical Uplink Control Channel), RACH (Downlink Control Information (DCI) including Random Access Channel, Random Access Radio Network Temporary Identifier (RA-RNTI)), and Physical Broadcast Channel (PBCH).

The data channels include PDSCH and PUSCH (Physical Uplink Shared Channel). Data may mean data transmitted via the data channels.

The control signal and reference signal processing unit 240 may also transmit capability information of the UE200 to the network. In particular, in this embodiment, the control signal and reference signal processing unit 240 may transmit UE Capability Information related to UL Tx switching to the gNB100.

Specifically, the control signal and reference signal processing unit 240 may transmit information (UE Capability Information) indicating the threshold of the number of frequency bands or carriers supported by the Tx chain to the network. The control signal and reference signal processing unit 240 may also transmit information indicating the configuration of the antenna port and/or the Tx chain (which may include whether Option is enabled) and capability (Supported frequency bands, frequency ranges, etc.) to the network.

Information indicating the threshold of the number of frequency bands or carriers supported by the Tx chain may be provided (indicated) from the network. The control signal and reference signal processing unit 240 may receive information indicating the threshold from the network. The information indicating the threshold may be indicated by the signaling of the upper layer (For example, RRC), the downlink control information (DCI), or the control element (CE) of the medium access control layer (MAC).

The control signal and reference signal processing unit 240 may also receive from the network at least either of the indication information of the switching mechanism for UL Tx switching or the indication information indicating the operation when the band limit related to UL Tx switching is applied.

Specifically, the control signal and reference signal processing unit 240 may receive the indication information of the switching mechanism to be applied to the UE200 among the plurality of switching mechanisms. The switching mechanism indicated by the indication information may be one or a plurality of switching mechanisms may be indicated together with the application conditions. The control signal and reference signal processing unit 240 may also receive the indication information indicating the operation (described later) when the band limit related to UL Tx switching is applied.

The encoding/decoding unit 250 performs data division/concatenation, channel coding/decoding, etc. for each predetermined communication destination (qNB100 or other qNB).

Specifically, the encoding/decoding unit 250 divides the data output from the data transmission and reception unit 260 into predetermined sizes, and performs channel coding on the divided data. The encoding/decoding unit 250 decodes the data output from the modulation and demodulation unit 230, and concatenates the decoded data.

The data transmission and reception unit 260 transmits and receives Protocol Data Units (PDU) and Service Data Units (SDU). Specifically, the data transmission and reception unit 260 assembles/disassembles PDUs/SDUs in multiple layers (Media Access Control Layer (MAC), Radio Link Control Layer (RLC), Packet Data Convergence Protocol Layer (PDCP), and the like). The data transmission and reception unit 260 also executes data error correction and retransmission control based on hybrid automatic repeat request (ARQ).

The control unit 270 controls each functional block constituting the UE200. In particular, in this embodiment, the control unit 270 can perform control related to UL Tx switching.

Specifically, the control unit 270 may select a switching mechanism to be applied to UL Tx switching using the configuration (2Tx-2Tx) of the antenna port and Tx chain of the radio signal transmission and reception unit 210.

In addition, to reduce the complexity of the UE200, the control unit 270 can perform configuration of the antenna port and Tx chain according to the case where the frequency band (band) that can be transmitted using the two antenna ports is limited or the combination of bands that can be simultaneously transmitted is limited.

Specifically, it may be assumed that the control unit 270 configures one Tx chain when using a band (frequency band) that is limited in transmission by the two antenna ports. In other words, the control unit 270 may use only one Tx chain and not configure the other Tx chain when using a band that is limited in transmission by the two antenna ports.

Alternatively, it may be assumed that the control unit 270 configures two Tx chains when using a band that is limited in transmission by the two antenna ports. That is, the control unit 270 may allow up to two Tx chains to be configured even for a band for which transmission by two antenna ports is restricted, and may assume that only the antenna port configuration is disabled.

Note that such Tx chain configuration may be applied to both the dual UL case and the switched UL case, or it may be applied to either of them. In addition, the number of antenna ports and Tx chains may be more than two, and it may assume that the control unit 270 will configure a Tx chain that is less than the number of antenna ports when the number of bands that can be transmitted using the antenna ports is limited.

In addition, the control unit 270 may assume that the Tx chain configuration is disabled when a combination of bands (frequency bands) for which simultaneous transmission is restricted is used. That is, when a band corresponding to a band combination for which simultaneous transmission is restricted is used, the control unit 270 may not configure a Tx chain corresponding to the band combination.

Alternatively, the control unit 270 may assume that the Tx chain configuration is enabled when a band combination for which simultaneous transmission is restricted is used. That is, even when a band corresponding to a band combination for which simultaneous transmission is restricted is used, the control unit 270 may configure a Tx chain corresponding to the band combination and assume that only the antenna port configuration is disabled.

A specific configuration example of the antenna port and Tx chain in the case where the band that can be transmitted by two antenna ports is limited or the combination of bands that can be transmitted simultaneously is limited will be described later.

### (3) Operation of Radio Communication System

Next, the operation of the radio communication system 10 will be described. Specifically, the operation related to the UE200 in the case where the band limitation related to UL Tx switching is applied will be described.

### (3.1) Assumptions and Issues

As described above, in 3GPP Release 18, it is assumed that UL transmission can be switched between 3 or 4 bands (CC). As the number of switchable bands increases in this way, the pattern of UL Tx switching also increases dramatically.

In the case of 3 bands, the maximum number of cases is 6 cases (in the case of dual UL cases). In the case of 4 bands, the maximum number of cases is 10 cases (in the case of dual UL cases).

In order to reduce the complexity of the UE200 (which may include reducing the processing load), it is assumed that the bands that can be transmitted by two antenna ports are limited, or that the combination of bands that can be simultaneously transmitted is limited, as described above.

However, the state (handling) of the Tx chain when this band is used is not clear. Therefore, there is a concern that the UE200 cannot always perform appropriate operations with respect to UL Tx switching.

### (3.1.1) Limiting the Bands That Can Be Transmitted by Two Antenna Ports

In the case of the dual UL case (simultaneous transmission by two bands), for example, if there is a restriction that transmission by two antenna ports (abbreviated as “port” as appropriate) is not allowed in BAND D, even in the case of 1 port transmission in BAND D, 2 Tx chains (abbreviated as “2 Tx chains” as appropriate) may be connected to BAND D (the number of cases does not change).

In the case of the switched UL case (transmission by only a single band), for example, if there is a restriction that transmission by 2 ports is not allowed in BAND D, even in the case of 1 port transmission in BAND D, 2 Tx chains must be configured for BAND D (assuming that the same provisions as in 3GPP Release 17 are applied). In this case, 2 Tx chains must be switchable to BAND D (see FIG. 3).

### (3.1.2) Limiting the Combination of Bands That Can Be Simultaneously Transmitted

In the case of limiting the combination of bands that can be simultaneously transmitted, only the dual UL case is applicable. For example, if there is a restriction that simultaneous transmission by BAND C and D is not allowed, the state of the Tx chain in Case 1 (described later) may occur when only BAND C or BAND D is transmitted (the number of cases does not change).

### (3.2) Operation Example 1

This operation example corresponds to the case where the bands that can be transmitted by two antenna ports are limited in UL Tx switching.

### (3.2.1) Operation Example 1-1

In the case of the dual UL case, the UE200 may apply one of the following assumptions in order to reduce the complexity of UL Tx switching. It should be noted that the assumption to be applied may be determined by notification from the network (gNB100) or may be configured in advance within the UE200.
(Alt 1): In a band where transmission via 2 ports is restricted, only 1 Tx chain is assumed in the band.
(Alt 2): In a band where transmission via 2 ports is restricted, up to 2 Tx chains can be assumed in the band.

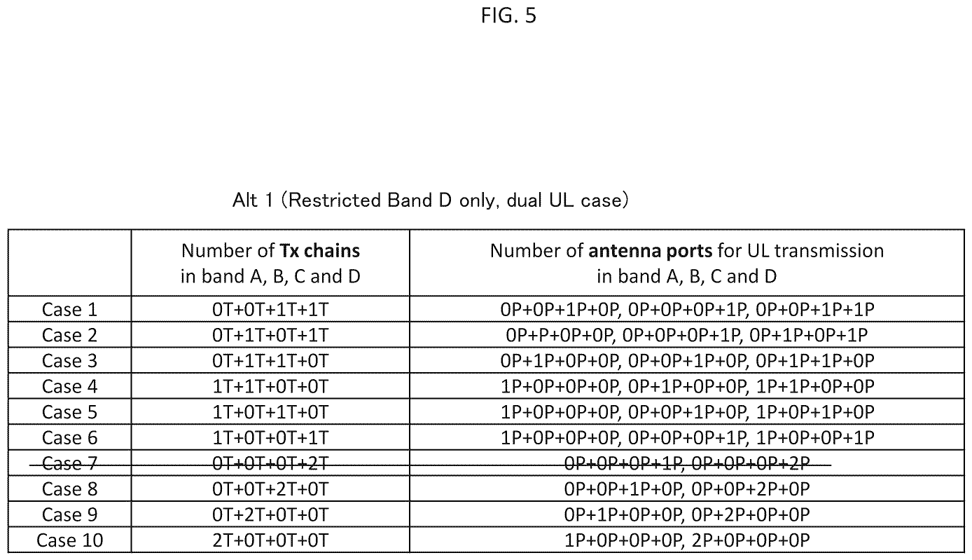

FIG. 5 shows an example of configuring the antenna port and Tx chain (Alt 1) according to the operation example 1-1. FIG. 5 shows an example in which transmission by 2 ports is limited only for BAND D. As described above, in the case of 4 bands, 10 cases of UL Tx switching patterns (antenna port and Tx chain configurations) can be considered, but the UE200 may assume that Case 7 corresponding to BAND D is excluded.

In FIG. 5, the notation of “0P+0P+0P+1P, 0P+0P+0P+2P” and “0T+0T+0T+2T” means the number of Tx chains (T) and antenna ports (P) configuration for BAND A, B, C, and D, respectively (hereinafter the same).

According to this operation example, even in the dual UL case in which transmission by 2 antenna ports is limited, the UE200 can perform appropriate operations regarding UL Tx switching.

### (3.2.2) Operation Example 1-2

In the case of the switched UL case, the UE200 may apply one of the following assumptions to reduce complexity in UL Tx switching. It should be noted that the assumption to be applied may be determined by notification from the network (gNB100), or it may be preconfigured in the UE200.
(Alt 1): In a band for which transmission via 2 ports is restricted, it is assumed that only 1 Tx chain can be configured in that band.

In other words, the UE200 that supports UL Tx switching in 3GPP Release 18 is different from the UE that supports UL Tx switching in 3GPP Release 17 and earlier, and it is assumed that there is no need to configure (assign) 2 Tx chain for the transmission target band. In this case, the same assumption may be applied to UL Tx switching in 3GPP Release 16 and 17.
(Alt 2): In a band for which transmission via 2 ports is restricted, it is assumed that up to 2 Tx chain can be configured in that band.
(Alt 3): In a band for which transmission via 2 ports is restricted, it is assumed that 0 Tx chain is configured in that band.

In other words, the UE200 does not need to configure the Tx chain when using a band whose transmission by 2 ports is restricted.

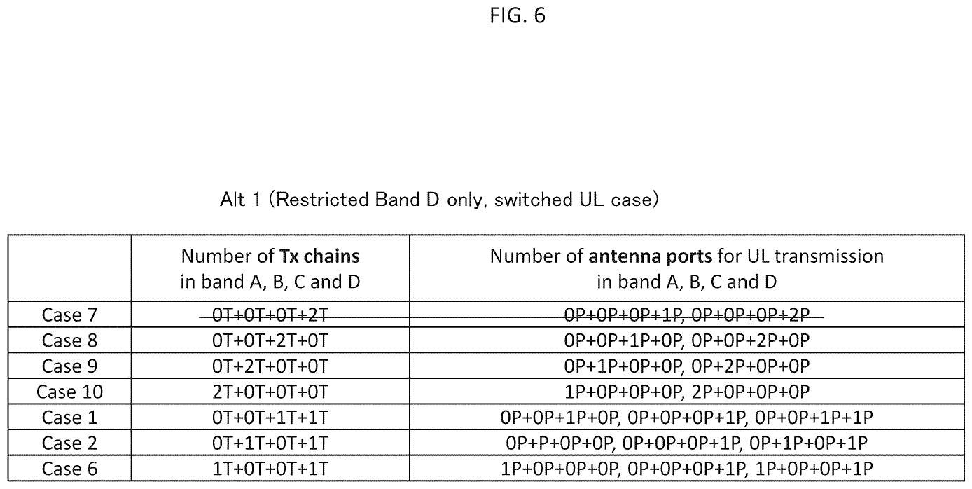

FIG. 6 shows an example of configuring the antenna port and Tx chain (Alt 1) according to operation example 1-2. FIG. 6 shows an example in which transmission by 2 ports is restricted only for BAND D. As shown in FIG. 6, in the case of switched UL case (Case 1, 2, 6~10), the UE200 may assume that Case 7 corresponding to BAND D is excluded.

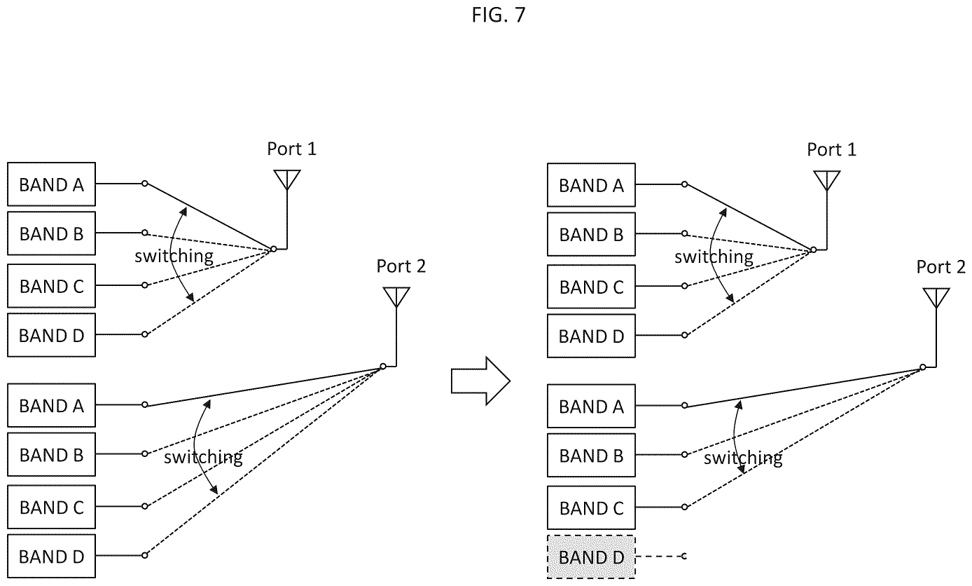

FIG. 7 shows an example of correspondence between the antenna port and Tx chain and bands according to operation example 1-2. As shown in FIG. 7, the UE200 may assume that BAND D is excluded from one Tx chain and configure the Tx chain.

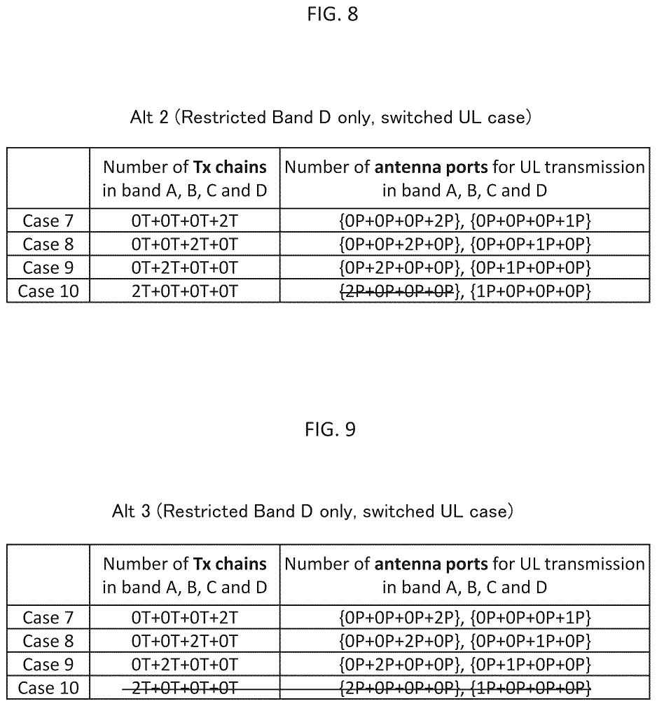

FIG. 8 shows an example of configuring the antenna port and Tx chain (Alt 2) according to operation example 1-2. FIG. 9 shows an example of configuration the antenna port and Tx chain (Alt 3) according to operation example 1-2. FIGS. 8 and 9 also show an example in which transmission by 2 ports is limited only in BAND D.

As shown in FIG. 8, the UE200 may exclude the configuration of “2P+0P+0P+0P.” Also, as shown in FIG. 9, the UE200 may exclude the configuration of Case 10.

In addition, in the above-described (Alt 1), that is, in the band in which transmission by 2 ports is limited, if it is assumed that only 1 Tx chain can be configurd in the band, the UE200 may further apply one of the following assumptions in the band in which another (other) Tx chain can be configured. It should be noted that the assumption to be applied may be determined by notification from the network (gNB100), or it may be predetermined in the UE200.
(Opt 1): Assume that a specific band can be configured.

In the switched UL case, for example, there are BAND A, B, and C as the bands subject to UL Tx switching, and in the case where 2 port transmission at BAND C is restricted, the UE200 may apply the following assumption.

Specifically, if UL transmission at BAND C is indicated and BAND A is configured, the UE200 may assume “1T+1T+1T” as the Tx chain configuration. If UL transmission at BAND C is indicated and BAND B is configured, the UE200 may assume “1T+1T+0T” as the Tx chain configuration.
(Opt 2): The priority is specified for the bands that can be configured, and the band with the highest priority is assumed to be configurable.

According to this operation example, even in a switched UL case in which the bands that can be transmitted by two antenna ports are limited, the UE200 can perform appropriate operations regarding UL Tx switching.

### (3.2.3) Operation Example 1-3

In (Alt 1) of operation example 1-2, that is, in a band in which transmission by 2 ports is restricted, if it is assumed that only 1 Tx chain can be configured in that band, the increase in the number of cases to be applied and the resulting uncertainty and ambiguity regarding the Tx chain (Ambiguity) may be a problem. Here, Ambiguity may mean that it cannot be determined whether any of Cases 1, 2 and 6 should be applied in UL Tx switching of switched UL case.

Therefore, the UE200 may apply any of the following methods to solve such Ambiguity. It should be noted that the method to be applied may be determined by notification from the network (qNB100), or it may be predetermined in the UE200.
(Alt 1): Ambiguity resolution method applied to the dual UL case of UL Tx switching of 3GPP Release 18 (reuse)
(Alt 2): Ambiguity resolution method specified separately from the Ambiguity resolution method applied to the dual UL case of UL Tx switching of 3GPP Release 18 For example, in Ambiguity resolution method, when 2 Tx chains are configured and Ambiguity occurs, it may be assumed that the case (pattern) of UL Tx switching is switched such that both of the serving cell (band) Tx chains designated to be transmitted are linked (basically the same as in 3GPP Release 17).

Also, for example, if 1 Tx chain is configured and Ambiguity occurs, any of the following rules may be applied.
(Alt 1): Interpret based on the rules specified by the 3GPP specifications
(Alt 2): Interpret based on the configuration from the network (gNB100)
(Alt 3): Interpret based on the capabilities reported by the UE200

According to this operation example, even if Ambiguity occurs in a switched UL case in which the bands that can be transmitted by two antenna ports are limited, the UE200 can perform an appropriate operation that resolves the Ambiguity.

### (3.3) Operation Example 2

This operation example corresponds to a case in which the combination of bands that can be transmitted simultaneously is limited in UL Tx switching.

When the combination of bands that can be simultaneously transmitted is limited, only the dual UL case is considered, but the UE200 may apply one of the following assumptions to reduce complexity in UL Tx switching. It should be noted that the assumption to be applied may be determined by notification from the network (qNB100), or it may be preconfigured in the UE200.
(Alt 1): For a band that can be simultaneously transmitted, it is assumed that the configuration of the Tx chain corresponding to that band combination is not allowed.
(Alt 2): For a band that can be simultaneously transmitted, it is assumed that the configuration of the Tx chain corresponding to that band combination is allowed.

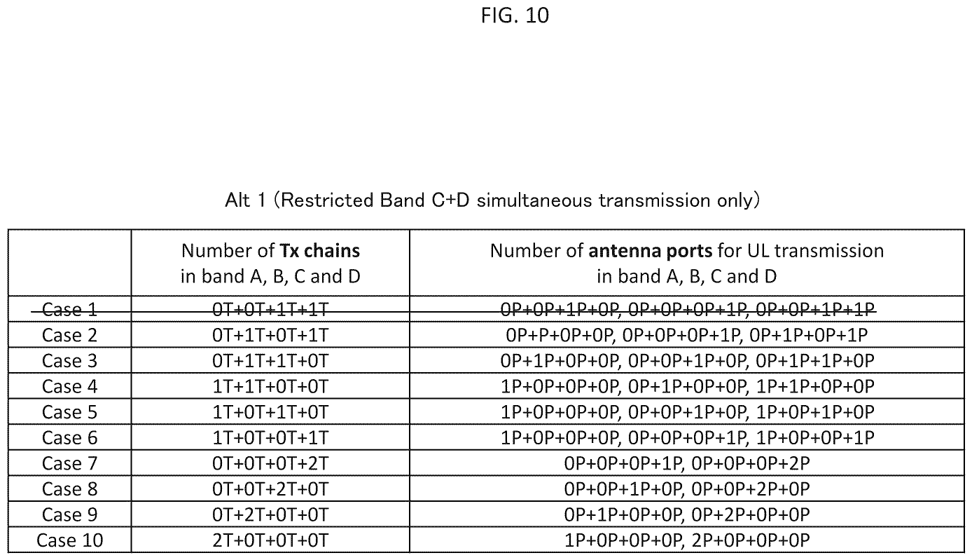

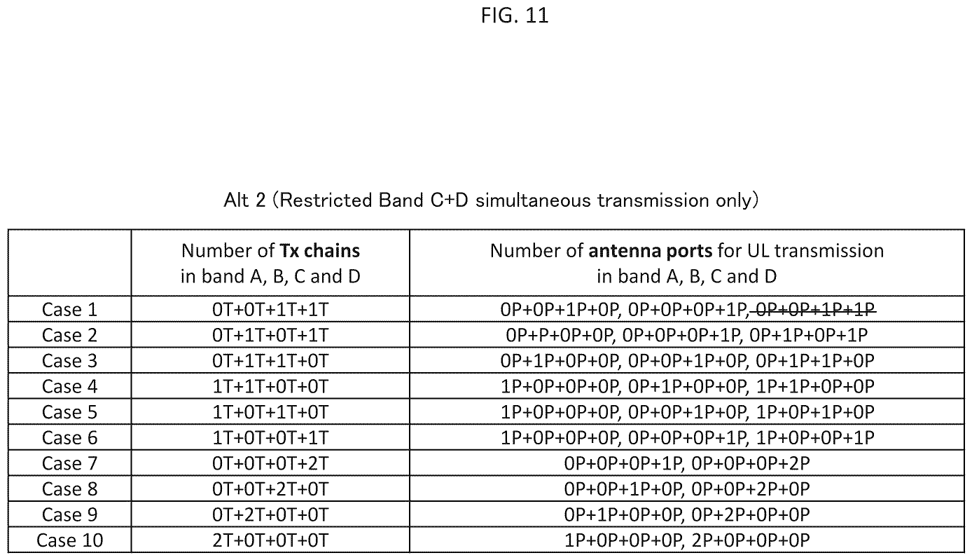

FIG. 10 shows an example of configuring the antenna port and the Tx chain (Alt 1) according to operation example 2. FIG. 11 shows an example of configuring the antenna port and the Tx chain (Alt 2) according to operation example 2. FIGS. 10 and 11 show examples in which simultaneous transmission is limited only in BAND C and D.

As shown in FIG. 10, the UE200 may assume that the configuration of the antenna port and Tx chain of Case 1 in which Tx chain is configured in BAND C and D are excluded. Alternatively, as shown in FIG. 11, the UE200 may assume that only the configuration of the antenna port for BAND C and D of Case 1 are excluded while applying the configuration of the Tx chain of Case 1 in which Tx chain is configurd in BAND C and D.

According to this operation example, even in the dual UL case in which the combination of bands that can be simultaneously transmitted is limited, the UE200 can perform appropriate operations regarding UL Tx switching.

### (3.4) Capability Information

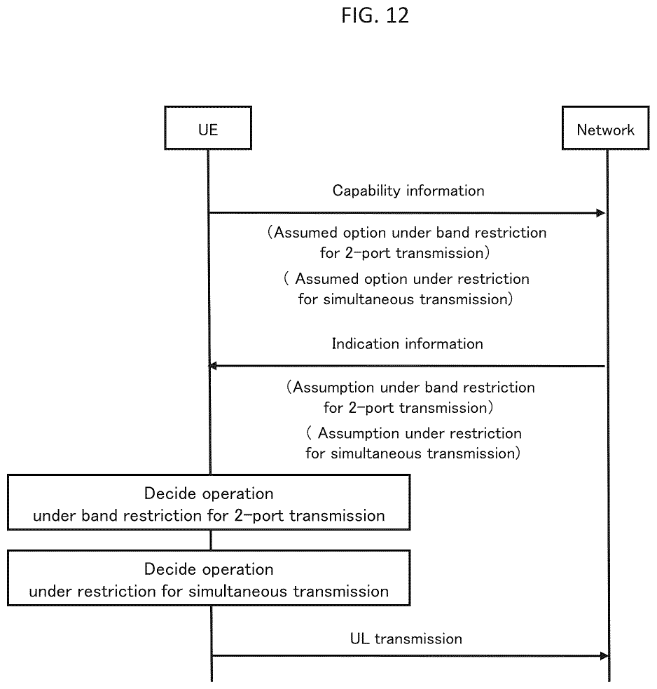

FIG. 12 shows an example sequence related to the transmission and reception of the capability information and indication information of UL Tx switching. For example, the UE200 may transmit the UE Capability Information including the assumed option when the 2 port transmittable band is limited (Alt 1, 2 in Example 1-1, Alt 1~3 in Example 1-2) and the assumed option when the simultaneous transmission is limited (Alt 1, 2 in Example 2) to the network.

The UE Capability Information related to the 2 port transmittable band limit can be reported for bands that can only transmit 1 port and can be any of the following:
(Alt 1): All bands that can only transmit 1 port are reported.
(Alt 2): One or more bands that can only transmit 1 port are reported for each UL Tx switching band combination.

The UE Capability Information related to the concurrent transmission limit can be reported for bands that cannot transmit concurrently and can be any of the following:
(Alt 1): All bands that cannot transmit concurrently are reported.
(Alt 2): One band that cannot be simultaneously transmitted is reported for each UL Tx switching band combination.

In addition, the UE Capability Information for resolving Ambiguity described above may be the same as Alt 1 and 2 of the UE Capability Information for limiting 2 port transmittable bands, or may be as follows:
(Alt 3): The band combination reported as a dual UL case is considered to be supported in the switched UL case.

If the UE Capability Information for limiting 2 port transmittable bands and resolving Ambiguity is not reported, the network may assume that there is no band that can transmit only 1 port.

Based on the UE Capability Information received from the UE200, the network (gNB100) may instruct the UE200 with indication information about the assumption (operation content) for limiting 2 port transmittable bands and the assumption (operation content) for limiting concurrent transmissions. The indication information may typically be an information element (IE) included in an RRC layer message, but it may also be a DCI or MAC CE.

Based on the indication information received from the network, the UE200 may determine the operation when limiting the 2 port transmittable band (configuration of the antenna port and Tx chain) and the operation when limiting the simultaneous transmission (configuring of the antenna port and Tx chain). The UE200 may apply UL Tx switching and perform UL transmission according to the determined operation content.

### (3.5) Others

In the above-described embodiments, an example of 3 bands (For example, BAND A, B, C) or 4 bands (BAND A, B, C, D) has been described, but the same operation may be applied when more bands are configured.

In addition, as described above, the number of antenna ports and Tx chains may be more than 2, and the UE200 may assume that if the number of bands that can be transmitted using the number of antenna ports is limited, the number of Tx chains less than the number of antenna ports may be configured.

In the above-described embodiment, it is assumed that the number of CCs per band is one and a total of four CCs are configured, but the configuration of such CCs is not limited. For example, the number of CCs per band may be two (total of 8 CCs), and some of the bands may have one CC per band (total of 5 to 7 CCs). Furthermore, the number of CCs per band may be three or more (within the same band). As described above, a band may be read as a carrier (also CC).

In addition, a Tx chain (transmission lines) may be simply called Tx, and may be interpreted as a radio transmission unit capable of supporting one or more bands.

### (4) Operational Effects

According to the operation example described above, the UE200 can realize proper operation including a Tx chain even when the band restriction regarding UL Tx switching is applied.

### (5) Other Embodiments

Although the embodiments have been described above, it is obvious to those skilled in the art that various modifications and improvements are possible without being limited to the description of the embodiments.

For example, in the embodiments described above, it is assumed that the UE200 transmits and receives capability information and indication information related to UL Tx switching with the network, but the UE200 may autonomously determine the operation when the band limitation related to UL Tx switching is applied.

In addition, in the above description, configure, activate, update, indicate, enable, specify, and select may be interchanged. Similarly, link, associate, correspond, and map may be interchanged, and allocate, assign, monitor, and map may be interchanged.

In addition, specific, dedicated, UE-specific, and UE-individual may be interchanged. Similarly, common, shared, group-common, UE-common, and UE-shared may be interchanged.

In the present disclosure, terms such as “precoding,” “precoder,” “weight,” “quasi-co-location (QCL),” “Transmission Configuration Indication state (TCI state),” “spatial relation,” “spatial domain filter,” “transmit power,” “phase rotation,” “antenna port,” “antenna port group,” “layer,” “number of layers,” “rank,” “resource,” “resource set,” “resource group,” “beam,” “beam width,” “beam angle,” “antenna,” “antenna element,” and “panel” may be used interchangeably.

A block diagram (FIG. 4) used in the description of the above-described embodiment shows a block of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions transmission is called a transmission unit (transmitting unit) or a transmitter. As described above, there is no particular limitation on the implementation method of any of them.

Furthermore, the gNB100 and UE200 (devices) described above may function as a computer that processes the radio communication method of this disclosure. FIG. 13 shows an example of the hardware configuration of the devices. As shown in FIG. 13, this device may be configured as a computer device including a processor 1001, a memory 1002, a storage 1003, a communication device 1004, an input device 1005, an output device 1006, and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 4) is implemented by any hardware component or combination of hardware components of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM) , and the like. The memory 1002 may be called a register, a cache, a main memory (main memory), etc. The memory 1002 may store a program (program code), a software module, etc. capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive) , a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

The devices such as the processor 1001 and the memory 1002 are connected by the bus 1007 for communicating information. The bus 1007 may be configured using a single bus, or may be configured using different buses between devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA), Some or all of these functional blocks may be realized by the hardware. For example, the processor 1001 may be implemented by using at least one of these hardware.

Information notification is not limited to the aspects/embodiments described in this disclosure, but may be performed using other methods. For example, information notification may be performed by physical layer signaling (e. g., Downlink Control Information (DCI), Uplink Control Information (UCI), higher layer signaling (e.g., RRC signaling, Medium Access Control (MAC) signaling, announcements (Master Information Block (MIB), System Information Block (SIB)), other signals, or combinations thereof. RRC signaling may also be referred to as RRC messages, such as RRC Connection Setup messages, RRC Connection Reconfiguration messages, and the like.

The aspects/embodiments described in this disclosure are Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (x is, for example, an integer, a decimal), Future Radio Access (FRA), New Radio (NR), W-CDMA (R), GSM (R), CDMA2000, Ultra Mobile Broadband (UMB), IEEE 802.11 (Wi-Fi (R)), IEEE 802.16 (WiMAX (R)), IEEE 802.20, Ultra-WideBand (UWB), Bluetooth (R), It may be applied to at least one of the systems utilizing other suitable systems and the next generation systems extended thereon. Further, a plurality of systems may be combined (for example, a combination of at least one of the LTE and the LTE-A with the 5G).

The processing procedures, sequences, flowcharts, etc. of each aspect/embodiment described in the present disclosure may be changed in order as long as there is no contradiction. For example, the method described in the present disclosure presents the elements of the various steps using an exemplary order and is not limited to the particular order presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched with practice. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and symbol may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors) . In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head; RRH)).

The term “cell” or “sector” refers to a part or all of the coverage area of a base station and/or a base station subsystem that performs communication service in this coverage.

In this disclosure, the transmission of information by a base station to a terminal may be interpreted as the base station instructing the terminal to control and operate based on information.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile means any movable object at any speed. It also naturally includes the case where the mobile is stationary. The mobile includes, but is not limited to, vehicles, transport vehicles, automobiles, motorcycles, bicycles, connected cars, excavators, bulldozers, wheel loaders, dump trucks, forklifts, trains, buses, rear cars, rickshaws, ships and other watercrafts, airplanes, rockets, satellites, drones, multicopters, quadcopters, balloons, and objects mounted thereon. The mobile may also be an autonomous mobile based on operating instructions. It may be a vehicle (For example, cars, airplanes, etc.), an unmanned mobile (For example, drones, self-driving cars, etc.), or a robot (manned or unmanned). At least one of a base station and a mobile station can be a device that does not necessarily move during the communication operation. For example, at least one of the base station and the mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, uplink channel and downlink channel may be read as side channel (or side link).

Similarly, mobile station in this disclosure may be read as base station. In this case, the base station may have the function of the mobile station.

A radio frame may be composed of one or more frames in the time domain. Each frame or frames in the time domain may be referred to as a subframe. A subframe may be further configured by one or more slots in the time domain. The subframe may have a fixed time length (e. g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units larger than the minislot may be called PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframe and TTI may be a subframe (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LIE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots constituting the minimum time unit of the scheduling (the number of mini-slots) may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBS included in a slot or minislot, the subcarriers included in RBS, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, references to the first and second elements do not mean that only two elements can be employed there, or that the first element must somehow precede the second element.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. (looking up, search, inquiry) and may include, for example, judging, calculating, computing, processing, deriving, investigating, searching (For example, searching in a table, database, or another data structure), ascertaining, and the like. In addition, “judgment” and “decision” may include regarding receiving (For example, receiving information), transmitting (For example, sending information), input, output, and accessing (For example, accessing data in memory) as “judgment” or “decision”. In addition, “judgment” and “decision” may include regarding resolving, selecting, choosing, establishing, and comparing as “judgment” or “decision”. In other words, “judgment” and “decision” may include regarding some action as “judgment” or “decision”. Moreover, “judgment (decision)” may be read as “assuming,” “expecting,” “considering,” and the like.

In this disclosure, the term “A and B are different” may mean “A and B are different from each other.” It should be noted that the term may mean “A and B are each different from C.” Terms such as “leave,” “coupled,” or the like may also be interpreted in the same manner as “different.”

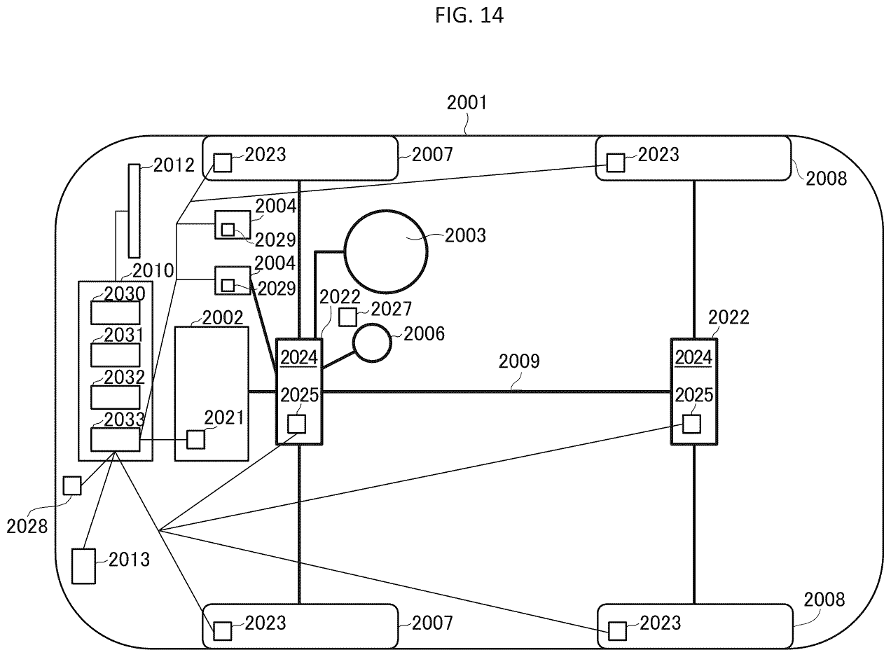

FIG. 14 shows an example of the configuration of the vehicle 2001. As shown in FIG. 14, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021~2029, an information service unit 2012, and a communication module 2013.

The drive unit 2002 is composed of, for example, an engine, a motor, and an engine-motor hybrid. The steering unit 2003 includes at least a steering wheel and is configured to steer at least one of the front and rear wheels based on the operation of the steering wheel operated by the user. The electronic control unit 2010 consists of a microprocessor 2031, a memory (ROM, RAM) 2032 and communication ports (10 ports) 2033. The electronic control unit 2010 receives signals from various sensors 2021~2027 provided in the vehicle. The electronic control unit 2010 may be referred to as an ECU (Electronic Control Unit).

The signals from the various sensors 2021~2028 include a current signal from a current sensor 2021 for sensing the current of a motor, a speed signal of a front wheel and a rear wheel acquired by an rpm sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal depressing amount signal acquired by an accelerator pedal sensor 2029, a brake pedal depressing amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 comprises various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to the occupants of the vehicle 2001 by utilizing information acquired from an external device via the communication module 2013 or the like.

The information service unit 2012 may include an input device (e.g. keyboard, mouse, microphone, switch, button, sensor, touch panel, etc.) that accepts input from the outside or an output device (e. g. displays, speakers, LED lamps, touch panels, etc.) that performs output to the outside.

A driver assistance system unit 2030 consists of various devices, such as millimeter-wave radar, LiDAR (Light Detection and Ranging), camera, positioning locator (e.g. GNSS), map information (e.g. high-definition (HD) maps, self-driving car (AV) maps, etc. ), gyro system (e.g. IMU (Inertial Measurement Unit), INS (Inertial Navigation System), etc.), AI (Artificial Intelligence) chip, AI processor, which are used to provide functions to prevent accidents or reduce the driver's driving load, and one or more ECUs that control these devices. The driver assistance system unit 2030 also transmits and receives various information via the communication module 2013 to realize a driver assistance function or an automatic driving function.

The communication module 2013 can communicate with the microprocessor 2031 and components of the vehicle 2001 via a communication port. For example, the communication module 2013 transmits and receives data via the communication port 2033 to and from the microprocessor 2031, the memory (ROM, RAM) 2032, and the sensors 2021~2028 in the drive unit 2002, the steering unit 2003, the accelerator pedal 2004, the brake pedal 2005, the shift lever 2006, the left and right front wheels 2007, the left and right rear wheels 2008, the axle 2009, and the electronic control unit 2010 in the vehicle 2001.

The communication module 2013 is a communication device that can be controlled by the microprocessor 2031 of the electronic control unit 2010 and can communicate with external devices. For example, it transmits and receives various information to and from external devices via radio communication. The communication module 2013 may be either inside or outside the electronic control unit 2010. The external device may be, for example, a base station, a mobile station, etc.

The communication module 2013 transmits a current signal from a current sensor input to the electronic control unit 2010 to an external device via radio communication. The communication module 2013 also transmits, via radio communication, to an external device the speed signals of the front and rear wheels acquired by the rpm sensor 2022, the air pressure signals of the front and rear wheels acquired by the air pressure sensor 2023, the vehicle speed signals acquired by the vehicle speed sensor 2024, the acceleration signals acquired by the acceleration sensor 2025, the accelerator pedal depressing amount signals acquired by the accelerator pedal sensor 2029, the brake pedal depressing amount signals acquired by the brake pedal sensor 2026, the shift lever operation signals acquired by the shift lever sensor 2027, and the detection signals acquired by the object detection sensor 2028 for detecting obstacles, vehicles, pedestrians, etc., which are inputted to the electronic control unit 2010.

The communication module 2013 receives various kinds of information (traffic information, signal information, Inter-vehicular distance information, etc.) transmitted from an external device and displays them to the information service unit 2012 provided in the vehicle. The communication module 2013 also stores various information received from external devices in the memory 2032 available by the microprocessor 2031. Based on the information stored in the memory 2032, the microprocessor 2031 may the control drive unit 2002, the steering unit 2003, the accelerator pedal 2004, the brake pedal 2005, the shift lever 2006, the left and right front wheels 2007, the left and right rear wheels 2008, the axle 2009, the sensors 2021~2028, etc. provided in the vehicle 2001.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of this disclosure is for illustrative purposes and has no restrictive meaning to this disclosure.

### REFERENCE SIGNS LIST

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 output device
1007 Bus
2001 vehicle
2002 drive unit
2003 steering unit
2004 accelerator pedal
2005 brake pedal
2006 shift lever
2007 left and right front wheels
2008 left and right rear wheels
2009 axle
2010 electronic control unit
2012 information service unit
2013 communication module
2021 current sensor
2022 rpm sensor
2023 air pressure sensor
2024 speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port

1. A terminal comprising:
a transmission unit having at least two antenna ports and two transmission chains, and switches the antenna ports and the transmission chains; and
a control unit that assumes that one transmission chain is configured when a frequency band in which transmission by the two antenna ports is restricted is used.

2. A terminal comprising:
a transmission unit having at least two antenna ports and two transmission chains, and switches the antenna ports and the transmission chains; and
a control unit that assumes that two transmission chains are configured when a frequency band in which transmission by the two antenna ports is restricted is used.

3. A terminal comprising:
a transmission unit having at least two antenna ports and two transmission chains, and switches the antenna ports and the transmission chains; and
a control unit that assumes that the transmission chains cannot be configured when a combination of frequency bands in which simultaneous transmission is restricted is used.

4. A terminal comprising:
a transmission unit having at least two antenna ports and two transmission chains, and switches the antenna ports and the transmission chains; and
a control unit that assumes that the transmission chains can be configured when a combination of frequency bands in which simultaneous transmission is restricted is used.

5. A radio communication method comprising the steps of:
having at least two antenna ports and two transmission systems and switching the antenna ports and the transmission chains; and
assuming that one transmission chain is configured when a frequency band in which transmission by the two antenna ports is restricted is used.

6. A radio communication method comprising the steps of:
having at least two antenna ports and two transmission chains, and switching the antenna ports and the transmission chains; and
assuming that the transmission chains cannot be configured when using a combination of frequency bands in which simultaneous transmission is restricted.
